(19) United States
(12) Patent Application Publication
(10) Pub. No.: US 2010/0320074 A1
(43) Pub. Date: Dec. 23, 2010

(54) METHOD FOR PREPARING GALLIUM NITRIDE NANOPARTICLES

(75) Inventors: Woong CHOI, Seongnam-si (KR); Manish CHHOWALLA, London (GB); Seung-Yol JEONG, Changwon-si (KR); Jae-Young CHOI, Suwon-si (KR)

Correspondence Address: CANTOR COLBURN LLP, 20 Church Street, 22nd Floor, Hartford, CT, 06103, US

(73) Assignees: SAMSUNG ELECTRONICS CO., LTD., Suwon-si (KR); RUTGERS, THE STATE UNIVERSITY OF NEW JERSEY, New Brunswick, NJ (US)

(21) Appl. No.: 12/688,381

(22) Filed: Jan. 15, 2010

(30) Foreign Application Priority Data
Jun. 22, 2009 (KR) 10-2009-0055664

(51) Int. Cl. C01B 21/06

(52) U.S. Cl. 204/178; 977/899

(57) ABSTRACT

A method for preparing gallium nitride nanoparticles includes providing a pair of electrodes; the pair of electrodes being opposedly disposed to one another. One electrode of the pair of electrodes is filled with gallium nitride powder. The pair of electrodes is dipped in a liquid. An arc discharge is produced between the pair of electrodes. The arc discharge produces a plasma between the pair of electrodes.

### CROSS-REFERENCE TO RELATED APPLICATION

This application claims priority to Korean Patent Application No. 10-2009-0055664, filed on Jun. 22, 2009, and all the benefits accruing therefrom under 35 U.S.C. §119, the content of which in its entirety is herein incorporated by reference.

### BACKGROUND

1. Field

This disclosure relates to a method for preparing gallium nitride nanoparticles.

2. Description of the Related Art

Gallium nitride (often referred to as GaN) is a semiconductor compound that has a wide, direct band gap, and is stable at elevated temperature. These properties makes gallium nitride attractive for optoelectronic devices and high-frequency, high-power devices. As a result, the fabrication of high quality, epitaxial bulk gallium nitride has received a fair deal of attention.

Recently, nanoparticles of gallium nitride such as those in the form of nanotubes have also attracted interest, since the potential applications of gallium nitride nanoparticles are wide-ranging, from opto-electronics to energy generation to catalysis. For example, gallium nitride nanotubes have been predicted to be optically active in the visible wavelength region with their opto-electronic properties being tunable by varying the diameters and/or doping. Thus, gallium nitride nanotubes are being considered in applications such as microlasers (where the wavelength is controlled by the nanotube diameter); organic photovoltaics, where they are used as bulk heterojunction materials; a catalyst substrate for photolytic production of hydrogen from water; as well as for thermoelectric applications.

The synthesis of gallium nitride nanoparticles, in particular nanotubes, use either vacuum systems or furnaces with high temperature processing capabilities. These methods have the disadvantage that includes high initial investment and large operating costs in addition to producing low yields of the desired products. In addition, these processes use a time consuming and costly purification step.

It is therefore desirable to have a process that permits the generation of large quantities of nanoparticles with low cost equipment and minimum purification.

### SUMMARY

An exemplary aspect of the disclosure includes a method for providing gallium nitride nanoparticles.

Accordingly, one aspect of the disclosure provides a method for preparing gallium nitride nanoparticles of which the process is simplified and is less than other commercially available methods.

According to an exemplary embodiment, the method for preparing gallium nitride nanoparticles, includes providing a pair of electrodes; the pair of electrodes being opposedly disposed to one another; filling either one of the pair of electrodes with gallium nitride powder; dipping the pair of electrodes in a liquid; and performing producing an arc discharge to supply plasma between the pair of electrodes; the arc discharge producing a plasma between the pair of electrodes.

The liquid may include one selected from the group consisting of liquid nitrogen, an aqueous liquid, liquid ammonia, liquid helium, alcohol, acetone, chloroform, and combinations thereof.

The liquid may further include a salt such as sodium chloride, potassium chloride, or combinations thereof.

The process of filling either electrode of the pair of electrodes with gallium nitride powder may further include adding a catalyst together with the gallium nitride powder.

The process of performing the arc discharge may include supplying a current of at least 30 amperes to the electrodes.

It may further include drying after producing the arc discharge.

The gallium nitride nanoparticles may include gallium nitride nanorice, gallium nitride nanowires, gallium nitride nanotubes, or combinations thereof.

In one aspect, a method for preparing gallium nitride nanoparticles includes providing a pair of electrodes; the pair of electrodes being opposedly disposed to one another; filling either one of the pair of electrodes with gallium nitride powder; dipping the pair of electrodes in a liquid; and forming gallium nitride nanoparticles having at least two different shapes simultaneously by producing an arc discharge between the pair of electrodes.

The gallium nitride nanoparticles may include at least two types of nanoparticles; the nanoparticles being selected from the group consisting of gallium nitride nanorice, gallium nitride nanowire, and gallium nitride nanotubes.

The gallium nitride nanorice, the gallium nitride nanowires, and the gallium nitride nanotubes are separated into different layers in the liquid. The gallium nitride nanorice is positioned as the lowest layer, the gallium nitride nanowire is positioned as the middle layer, and the gallium nitride nanotubes are positioned as the uppermost layer.

The liquid includes liquid nitrogen, aqueous liquid, liquid ammonia, liquid helium, alcohol, acetone, chloroform, or a combination comprising at least one of the foregoing liquids.

The liquid may further include a salt. The salt may include sodium chloride, potassium chloride, or a combination comprising at least one of the foregoing salts.

The arc discharge may be formed with a current of at least 30 amperes.

### BRIEF DESCRIPTION OF THE DRAWINGS

FIG. 1 is a schematic view showing an exemplary method for preparing gallium nitride nanoparticles;

FIG. 2 is a schematic view enlarging the section ‘A’ from the FIG. 1;

FIG. 3 is a schematic view showing nanoparticles obtained according to one exemplary embodiment by using the method disclosed herein;

FIG. 4A is an enlarged photomicrograph of a particle of a gallium nitride nanorice obtained by using the method disclosed herein; FIG. 4B is a magnified view of FIG. 4A of a particle of a gallium nitride nanorice obtained by using the method disclosed herein;

FIGS. 5A, 5B, 5C and 5D are enlarged photomicrographs of a particle of a gallium nitride nanowire obtained by using the method disclosed herein; and

FIGS. 6A and 6B are enlarged photomicrographs of a particle of a gallium nitride nanotube obtained by using the method disclosed herein.

### DETAILED DESCRIPTION

The disclosure will be described more fully hereinafter in the following detailed description of the present invention, in which some but not all embodiments of the invention are described. This invention may be embodied in many different forms and is not be construed as limited to the embodiments set forth herein; rather, these embodiments are provided so that this disclosure will satisfy applicable legal requirements.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Transition phrases such as “includes”, “including” or “comprising” are inclusive of the transition phrases “consisting of” or “consisting essentially of”.

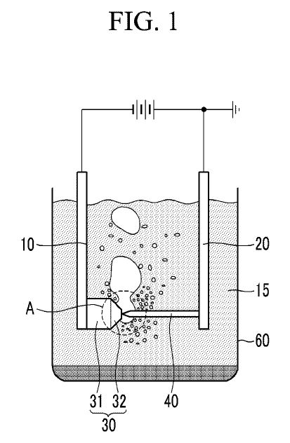

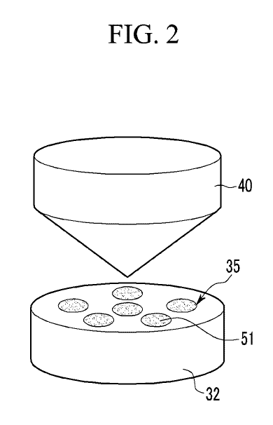

Hereinafter, a method of preparing gallium nitride nanoparticles according to one exemplary embodiment is described with reference to the FIGS. 1 and 2.

FIG. 1 is a schematic view showing an exemplary method for preparing gallium nitride nanoparticles, and FIG. 2 is a schematic view enlarging the section ‘A’ from the FIG. 1.

In one embodiment, a method for preparing gallium nitride nanoparticles includes providing a pair of electrodes, filling one electrode of the pair of electrodes with gallium nitride powder, dipping the pair of electrodes in a liquid, and producing a plasma via an arc discharge between the pair of electrodes.

FIG. 1 depicts the pair of electrodes 30 and 40 of which one electrode 30 or 40 is an anode, while the other is a cathode. For better understanding and ease of description, they are described as anode 30 and cathode 40, but this may be reversed.

Referring to FIG. 1 and FIG. 2, the anode 30 includes a cylindrical supporting part 31 and a discharge part 32 that is disposed on the supporting part 31. The discharge part 32 has a plurality of holes 35.

The cathode 40 is in the shape of a bar and has a pointed end (also termed the “terminal end”) facing the anode 30. The anode 30 and the cathode 40 are opposingly disposed to each other. The discharge part 32 of the anode 30 and the terminal end of the cathode 40 face each other. The discharge to form the plasma is performed between the discharge part 32 of the anode and the terminal end of the cathode 40.

The anode 30 and/or the cathode 40 may include an electrically conductive material. Examples of electrically conductive materials are carbonaceous materials, metals or ceramics. Examples of carbonaceous materials include graphite, carbon fibers, carbon nanotubes, or the like, or a combination comprising at least one of the foregoing carbonaceous materials. Examples of a metal include tungsten (W), molybdenum (Mo), or alloys thereof, or the like, or a combination comprising at least one of the foregoing metals. Examples of electrically conductive ceramics are indium tin oxide, indium zinc oxide, tin oxide, antimony oxide, or the like, or a combination comprising at least one of the foregoing electrically conductive ceramics.

While the FIGS. 1 and 2 depict a single anode 30 and a single cathode 40, two or more anodes 30 and cathodes 40 may be used. In one embodiment, a plurality of anodes 30 and cathodes 40 may be used.

Then, gallium nitride powder 51 is filled into a plurality of holes 35 that are contained in the discharge part 32. The gallium nitride powder 51 may be manufactured by mixing ammonia gas into melted gallium.

In addition, a catalyst may be added to the plurality of holes 35 together with the gallium nitride powder 51. The catalyst may be selected from the group consisting of nickel (Ni), cobalt (Co), iron (Fe), osmium (Os), palladium (Pd), yttrium (Y), gold (Au), gallium (Ga), aluminum (Al), and combinations thereof. The catalyst may be included in amounts of about 0.1 to about 10 weight fraction based on the 100 weight fraction of the gallium nitride powder. The catalyst may be included in amounts of about 0.1 to about 1 weight fraction based on the 100 weight fraction of the gallium nitride powder. The nanoparticles may have uniform characteristics by including these catalysts.

As shown in FIG. 1, the anode 30 and cathode 40 are disposed into a chamber 60 filled with a liquid 15.

The liquid 15 includes at least one selected from the group consisting of liquid nitrogen, an aqueous liquid, liquid ammonia, liquid helium, alcohol, acetone, chloroform, and combinations thereof. The aqueous liquid may include distilled water, deionized water, filtered water, or the like, or a combination comprising at least one of the foregoing aqueous liquids.

The liquid 15 may include a dissolved or suspended salt. The salt may include, for example, sodium chloride (NaCl), potassium chloride (KCI), or combinations thereof, but is not limited thereto. The salt may be included in amounts of about 1 to about 90 wt% based on the amount of the liquid. The salt may be included in amounts of about 10 to about 50 wt% based on the amount of the liquid. The salt may be suitably mixed with the liquid 15 and effectively dope the gallium nitride nanoparticles as is described below.

The anode 30 and the cathode 40 are in electrical communication with electrode rods 10 and 20, respectively. The electrode rods 10 and 20 are made of a conductive material such as a metal. The anode 30 and the cathode 40 are each connected to a power supply (not shown) through the electrode rods 10 and 20.

Next, the gallium nitride powder 51 in the holes 35 of the anode 30 is contacted with the pointed end of the cathode 40, and both the anode 30 and the cathode 40 are supplied with a voltage to produce an arc discharge. The arc discharge may occur with a direct current (“DC”) voltage of about 5 to 30 volts and a current of 30 amperes or more applied between the anode 30 and the cathode 40.

Plasma is generated between the anode 30 and the cathode 40, and gallium nitride powder 51 is consumed from the holes 35 while producing the arc discharge. As the gallium nitride powder 51 from a first hole 35 is consumed, the cathode 40 may be moved to contact the gallium nitride powder 51 in adjacent holes 35.

The liquid 15 may be agitated during the arc discharge. The liquid 15 prevents the contamination of gallium nitride nanoparticles and effectively cools heat generated by the plasma. The cooling of the plasma produces manufacturing conditions (over a period of time) that are similar to the initial manufacturing conditions. This results in gallium nitride nanoparticles of a particular quality being continuously produced.

It is thus possible to obtain gallium nitride nanoparticles from the consumed gallium nitride powder 51. The gallium nitride nanoparticles have a high level of crystallinity since they are obtained in the high temperature plasma state as a result of heat produced by the arc discharge.

The obtained gallium nitride nanoparticles have at least two different shapes. The gallium nitride nanoparticles may include gallium nitride nanorice having the shape of a rice grain with a convex center, gallium nitride nanowires having a filled center, and gallium nitride nanotubes having a conduit-like shape that is hollow in the center.

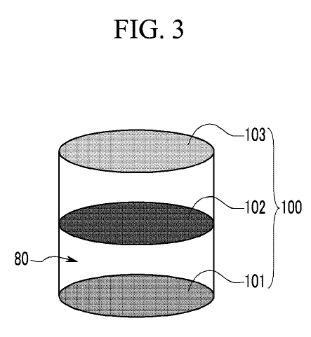

The mixture of synthesized gallium nitride nanorice, the gallium nitride nanowires, and the gallium nitride nanotubes are collected and sonicated in deionized water. Synthesized nanoparticles are separated into discrete layers in the deionized water, as shown in FIG. 3. This permits the separation of the different types gallium nitride nanoparticles from each other and their collection in large quantities respectively.

FIG. 3 is an exemplary schematic view showing the separation of the respective nanoparticles when they are subjected to sonication in deionized water.

As shown in FIG. 3, the gallium nitride nanoparticles 100 are separated into layers depending upon the density in the liquid 80. The gallium nitride nanorice 101 may be positioned in the lowest layer, the gallium nitride nanowire 102 may be positioned in the middle layer, and the gallium nitride nanotubes 103 may be positioned in the uppermost layer. The liquid 80 may be, for example, deionized water.

The obtained gallium nitride nanorice 101, gallium nitride nanowires 102, and gallium nitride nanotubes 103 may each be gathered and dried to remove the liquid that is used to effect the separation. The drying process may be performed in an oven.

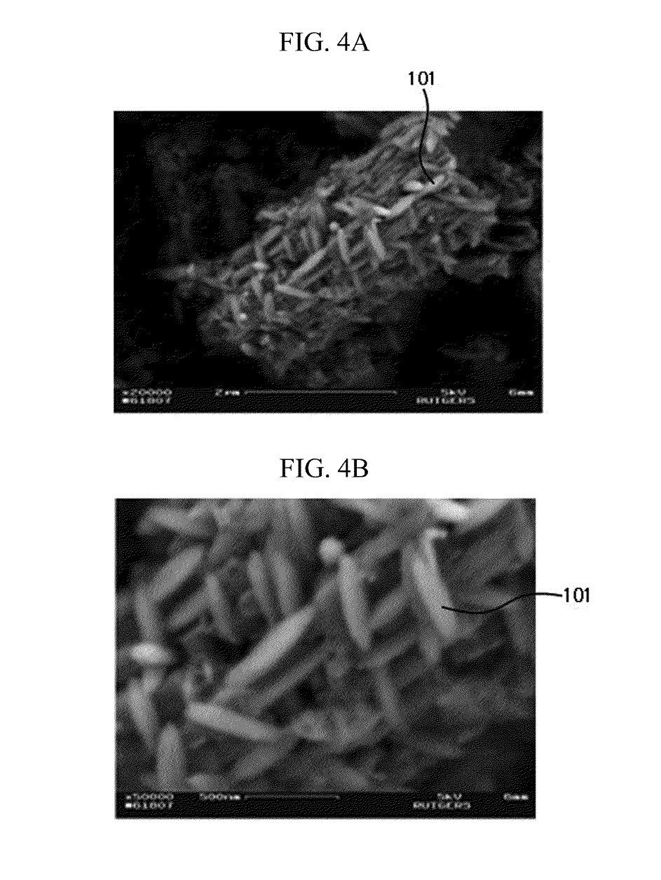

The obtained nanoparticles 100 may be seen in FIGS. 4 to 6, which are photomicrographs of the nanoparticles.

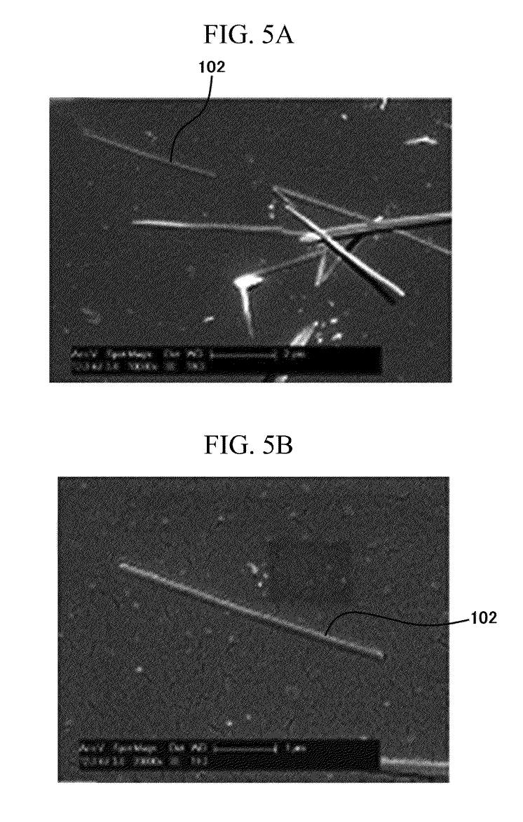

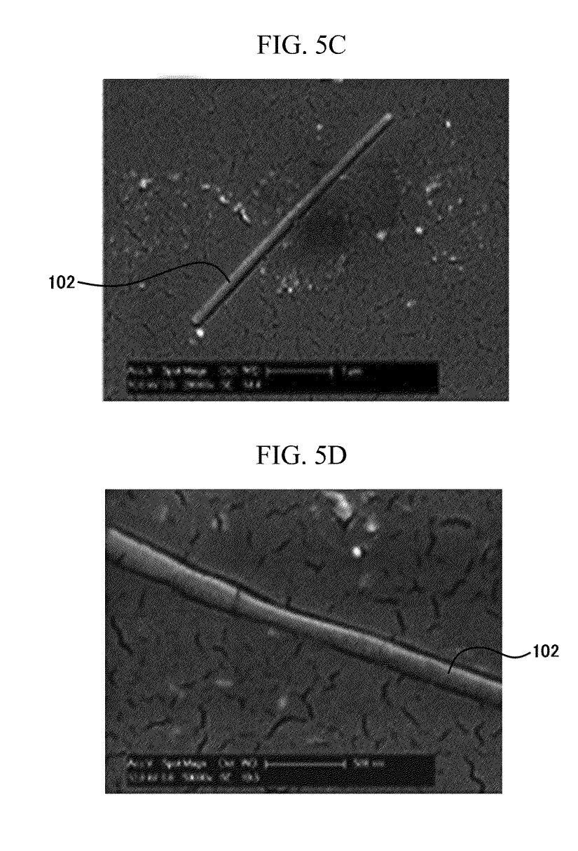

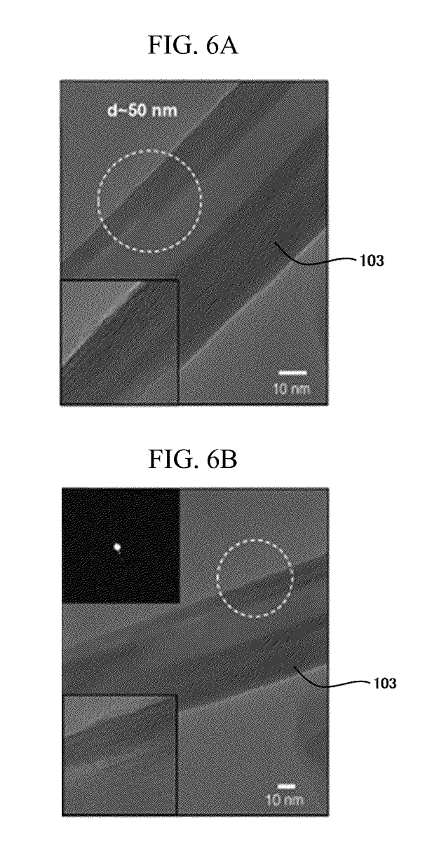

FIG. 4 is an enlarged photomicrograph of gallium nitride nanorice while FIG. 5 is an enlarged photomicrograph of gallium nitride nanowires, and FIG. 6 is an enlarged photomicrograph of gallium nitride nanotubes.

In one exemplary embodiment, the nanoparticles shown in FIG. 4 to FIG. 6 are formed while maintaining a DC voltage between the anode 30 and the cathode 40 of about 20 volts and an electrical current of about 50 amperes during the arc discharge. In this embodiment, the liquid used during the manufacture of the nanoparticles is liquid nitrogen.

Referring to FIGS. 4A and 4B it may be seen that the particles of gallium nitride nanorice 101 do not have any particular preferred orientation. From the FIG. 4B, it may be seen that the particles of gallium nitride have the shape of rice grains.

From the FIGS. 5A, 5B, 5C and 5D, it may be seen that the gallium nitride nanowire 102 has a rod-like shape. From the FIGS. 6A and 6B, it may be seen that the gallium nitride nanotube 103 has a hollow conduit-like shape.

The method for preparing gallium nitride nanoparticles is advantageous in that it does not use an additional deposition chamber, thereby decreasing the cost of the equipment. It also does not use the vacuum and high temperature conditions of other commercial processes thereby simplifying the manufacturing process.

The gallium nitride nanoparticles obtained from the plasma caused by the arc discharge have a high crystallinity. The gallium nitride nanoparticles have a different shape from each other and can be self-separated. This ability to self separate permits the use of a simple purifying process for separating the different types of gallium nitride nanoparticles.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for preparing gallium nitride nanoparticles, comprising:
providing a pair of electrodes, the pair of electrodes being opposedly disposed to one another;
filling either one of the pair of electrodes with gallium nitride powder;
dipping the pair of electrodes in a liquid; and
producing an arc discharge between the pair of electrodes; the arc discharge producing a plasma between the pair of electrodes.

2. The method of claim 1, wherein the liquid comprises one selected from the group consisting of liquid nitrogen, an aqueous liquid, liquid ammonia, liquid helium, alcohol, acetone, chloroform, and combinations thereof.

3. The method of claim 1, wherein the liquid further comprises a salt.

4. The method of claim 3, wherein the salt comprises one selected from the group consisting of sodium chloride, potassium chloride, and combinations thereof.

5. The method of claim 1, wherein the filling either one of the pair of electrodes with gallium nitride powder further comprises adding a catalyst together with the gallium nitride powder.

6. The method of claim 1, wherein the arc discharge is produced by supplying a current of at least 30 amperes.

7. The method of claim 1, further comprising drying after producing the arc discharge.

8. The method of claim 1, wherein the gallium nitride nanoparticles comprise gallium nitride nanorice, gallium nitride nanowire, gallium nitride nanotubes, or combinations thereof.

9. A method for preparing gallium nitride nanoparticles comprising:
providing a pair of electrodes; the pair of electrodes being opposedly disposed to one another;
filling either one of the pair of electrodes with gallium nitride powder;
dipping the pair of electrodes in a liquid; and
forming gallium nitride nanoparticles having at least two different shapes simultaneously by producing an arc discharge between the pair of electrodes.

10. The method of claim 9, wherein the gallium nitride nanoparticles comprise at least two types of nanoparticles selected from the group consisting of gallium nitride nanorice, gallium nitride nanowire, and gallium nitride nanotubes.

11. The method of claim 10, wherein the gallium nitride nanorice, the gallium nitride nanowires, and the gallium nitride nanotubes are separated into different layers in a liquid.

12. The method of claim 11, wherein the gallium nitride nanorice is positioned as the lowest layer, the gallium nitride nanowires are positioned as the middle layer, and the gallium nitride nanotubes are positioned as the uppermost layer.

13. The method of claim 11, wherein the liquid comprises one selected from the group consisting of a liquid nitrogen, an aqueous liquid, liquid ammonia, liquid helium, an alcohol, acetone, chloroform, and combinations thereof.

14. The method of claim 13, wherein the liquid further comprises a salt.

15. The method of claim 14, wherein the salt comprises one selected from the group consisting of sodium chloride, potassium chloride, and combinations thereof.

16. The method of claim 9, wherein the arc discharge is performed by supplying a current of at least 30 amperes.
